(19) United States
(12) Patent Application Publication
(10) Pub. No.: US 2026/0194615 A1
(43) Pub. Date: Jul. 9, 2026

(54) COMMUNICATION TERMINAL, COMMUNICATION SYSTEM, CONTROL METHOD, AND NON-TRANSITRY COMPUTER READABLE RECORDING MEDIUM

(71) Applicant: SHARP KABUSHIKI KAISHA, Sakai City, Osaka (JP)

(72) Inventors: TOMOKO UEKI, Sakai City, Osaka (JP); TOMOHISA YOSHIE, Sakai City, Osaka (JP); Takumi nishina, Sakai City, Osaka (JP); TOSHIYUKI NOBUOKA, Sakai City, Osaka (JP); SHUN UEKI, Sakai City, Osaka (JP)

(21) Appl. No.: 19/132,495

(22) PCT Filed: Oct. 6, 2023
(86) PCT No.: PCT/JP2023/036498

§ 371 Date: May 23, 2025

(30) Foreign Application Priority Data
Dec. 5, 2022 (JP) 2022-193987

(51) Int. Cl. G01S 5/02; G01S 1/68; H04W 64/00

(52) U.S. Cl. CPC G01S 5/02; G01S 1/68; H04W 64/006

(57) ABSTRACT

A communication terminal includes: a reception unit configured to receive a first signal and a second signal; a recording unit configured to record a first radio wave intensity representing a radio wave intensity of the first signal and a second radio wave intensity representing a radio wave intensity of the second signal; and a trigger generation unit configured to generate a first trigger in response to a change from a state of the first radio wave intensity being higher than the second radio wave intensity to a state of the first radio wave intensity being lower than the second radio wave intensity and to generate a second trigger in response to a change from a state of the first radio wave intensity being lower than the second radio wave intensity to a state of the first radio wave intensity being higher than the second radio wave intensity.

### TECHNICAL FIELD

The present disclosure relates to communication terminals, communication systems, control methods, and non-transitory computer-readable recording mediums. The present application claims the benefit of priority to Japanese Patent Application No. 2022-193987 filed in Japan on Dec. 5, 2022, the entire contents of which are incorporated herein by reference.

### BACKGROUND ART

Patent Literature 1 discloses technology to: chronologically acquire information related to reception signal strength at the time when a terminal device has received a radio wave transmitted by a plurality of communication terminals disposed in a space and information related to reception signal strength at the time when the plurality of communication terminals have received a radio wave transmitted by the terminal device; generate, for each of a plurality of communication devices, a displacement vector that has the location of the terminal device as the starting point; estimate the traveling direction of the terminal device on the basis of a resultant vector obtained by combining these displacement vectors; and estimate the location of the terminal device on the basis of the estimated traveling direction.

### CITATION LIST

### Patent Literature

Patent Literature 1: Japanese Unexamined Patent Application Publication No. 2016-075669

### SUMMARY

### Technical Problem

The technology disclosed in Patent Literature 1 requires three or more communication devices in the space to estimate the location of the terminal device. Furthermore, in the technology disclosed in Patent Literature 1, for example, building materials located on area boundaries in the space could absorb the radio waves transmitted by the communication terminals and the radio waves transmitted by the terminal device. Therefore, the geolocation precision could relatively decrease near the area boundaries in the space. In view of this situation, the present disclosure, in an aspect thereof, has an object to provide a communication terminal, a communication system, a control method, and a non-transitory computer-readable recording medium capable of geolocation near an area boundary with high precision.

### Solution to Problem

The present disclosure, in an aspect thereof, is directed to a communication terminal including: a reception unit configured to receive a first signal and a second signal; a recording unit configured to record a first radio wave intensity representing a radio wave intensity of the first signal and a second radio wave intensity representing a radio wave intensity of the second signal; and a trigger generation unit configured to generate a first trigger in response to a change from a state of the first radio wave intensity being higher than the second radio wave intensity to a state of the first radio wave intensity being lower than the second radio wave intensity and to generate a second trigger in response to a change from a state of the first radio wave intensity being lower than the second radio wave intensity to a state of the first radio wave intensity being higher than the second radio wave intensity.

The present disclosure, in an aspect thereof, is directed to a communication system including: a first transmission terminal configured to transmit a first signal; a second transmission terminal configured to transmit a second signal; and a communication terminal. The communication terminal includes: a reception unit configured to receive the first signal and the second signal; a recording unit configured to record a first radio wave intensity representing a radio wave intensity of the first signal and a second radio wave intensity representing a radio wave intensity of the second signal; and a trigger generation unit configured to generate a first trigger in response to a change from a state of the first radio wave intensity being higher than the second radio wave intensity to a state of the first radio wave intensity being lower than the second radio wave intensity and to generate a second trigger in response to a change from a state of the first radio wave intensity being lower than the second radio wave intensity to a state of the first radio wave intensity being higher than the second radio wave intensity.

The present disclosure, in an aspect thereof, is directed to a control method including: receiving a first signal and a second signal; recording a first radio wave intensity representing a radio wave intensity of the first signal and a second radio wave intensity representing a radio wave intensity of the second signal; and generating: a first trigger in response to a change from a state of the first radio wave intensity being higher than the second radio wave intensity to a state of the first radio wave intensity being lower than the second radio wave intensity; and a second trigger in response to a change from a state of the first radio wave intensity being lower than the second radio wave intensity to a state of the first radio wave intensity being higher than the second radio wave intensity.

The present disclosure, in an aspect thereof, is directed to a non-transitory computer-readable recording medium containing a program causing a computer to perform: a function of recording a first radio wave intensity representing a radio wave intensity of a first signal and a second radio wave intensity representing a radio wave intensity of a second signal; and a function of generating: a first trigger in response to a change from a state of the first radio wave intensity being higher than the second radio wave intensity to a state of the first radio wave intensity being lower than the second radio wave intensity; and a second trigger in response to a change from a state of the first radio wave intensity being lower than the second radio wave intensity to a state of the first radio wave intensity being higher than the second radio wave intensity.

### BRIEF DESCRIPTION OF DRAWINGS

FIG. 1 is a block diagram of an exemplary overall configuration of a communication system.

FIG. 2 is a diagram of exemplary locations of a first transmission terminal and a second transmission terminal.

FIG. 3A is a block diagram of an exemplary configuration of the first transmission terminal.

FIG. 3B is a block diagram of an exemplary configuration of the second transmission terminal.

FIG. 4 is a block diagram of an exemplary configuration of a communication terminal.

FIG. 5 is a block diagram of an exemplary configuration of a server.

FIG. 6 is a flow chart representing an exemplary operation of the communication terminal in accordance with Embodiment 1.

FIG. 7 is a diagram of exemplary travel paths of a person, carrying the communication terminal, moving between a first area and a second area.

FIG. 8 is a graph representing an exemplary first radio wave intensity recorded in a reception signal log and an exemplary second radio wave intensity recorded in the reception signal log.

FIG. 9 is a block diagram of an exemplary configuration of the communication terminal in accordance with a variation example of Embodiment 1.

FIG. 10A is a graph representing exemplary radio wave intensities of a first signal and a second signal.

FIG. 10B is a graph representing exemplary average travel values of the radio wave intensity of the first signal shown as an example in FIG. 10A and the radio wave intensity of the second signal shown as an example in FIG. 10A.

FIG. 11A is a diagram of an exemplary travel path of the communication terminal moving between the first area and the second area.

FIG. 11B is a graph representing exemplary temporal changes of the first radio wave intensity and the second radio wave intensity when the communication terminal moves along the travel path indicated as an example in FIG. 11A.

FIG. 12A is a diagram of an exemplary travel path of the communication terminal moving in the first area.

FIG. 12B is a graph representing exemplary temporal changes of the first radio wave intensity and exemplary temporal changes of the second radio wave intensity when the communication terminal moves along the travel path indicated as an example in FIG. 12A.

FIG. 13 is a diagram of exemplary locations of the first transmission terminal and the second transmission terminal in a communication system in accordance with Embodiment 4.

FIG. 14 is a diagram of an exemplary environment in which a plurality of first transmission terminals and a plurality of second transmission terminals are installed in the first area and the second area.

### DESCRIPTION OF EMBODIMENTS

### Embodiment 1

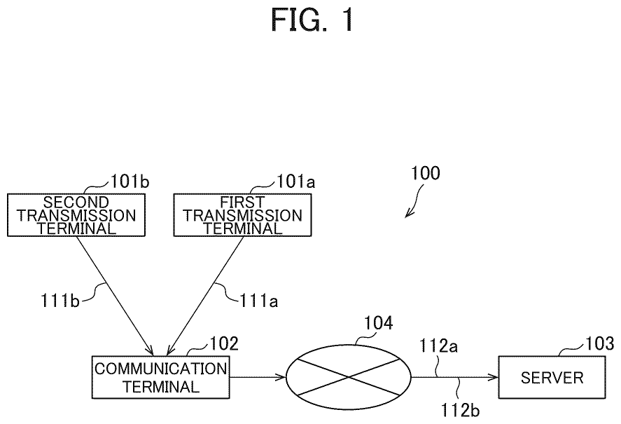

A description is now given of Embodiment 1 with reference to FIGS. 1 to 8. Note that identical and similar elements in the drawings are denoted by the same reference numerals, and redundant description may be omitted.

FIG. 1 is a block diagram of an exemplary overall configuration of a communication system 100. The communication system 100 includes a first transmission terminal 101a, a second transmission terminal 101b, a communication terminal 102, and a server 103. The communication terminal 102 and the server 103 are connected to each other over a network 104. For example, the network 104 is, for example, a mobile communications network or a Wi-Fi®.

The first transmission terminal 101a transmits a first signal 111a on a plurality of frequencies by near-field communication. The first signal 111a contains identification information of the first transmission terminal 101a. For example, the identification information of the first transmission terminal 101a is a Bluetooth® device address.

The second transmission terminal 101b transmits a second signal 111b on a plurality of frequencies by near-field communication. The second signal 111b contains identification information of the second transmission terminal 101b. For example, the identification information of the second transmission terminal 101b is a Bluetooth device address.

The communication terminal 102 generates first signal data 112a representing the identification information of the first transmission terminal 101a and the radio wave intensity of the first signal 111a in an associated manner to transmit the generated, first signal data 112a to the server 103. For example, the communication terminal 102 transmits the generated, first signal data 112a to the server 103 when the radio wave intensity of the first signal 111a is higher than or equal to the radio wave intensity of the second signal 111b.

Alternatively, the communication terminal 102 generates second signal data 112b representing the identification information of the second transmission terminal 101b and the radio wave intensity of the second signal 111b in an associated manner to transmit the generated, second signal data 112b to the server 103. For example, the communication terminal 102 transmits the generated, second signal data 112b to the server 103 when the radio wave intensity of the first signal 111a is lower than the radio wave intensity of the second signal 111b. For example, the communication terminal 102 is, for example, a smart watch, a card-type device, a ring-type device, an eyewear-type device, or a clothing-type device.

The server 103 is capable of communicating with the communication terminal 102. The server 103 stores the first signal data 112a and the second signal data 112b both transmitted by the communication terminal 102 to analyze the stored, first signal data 112a and the stored, second signal data 112b. Then, the server 103 outputs results of the analysis of either one or both of the stored, first signal data 112a and the stored, second signal data 112b.

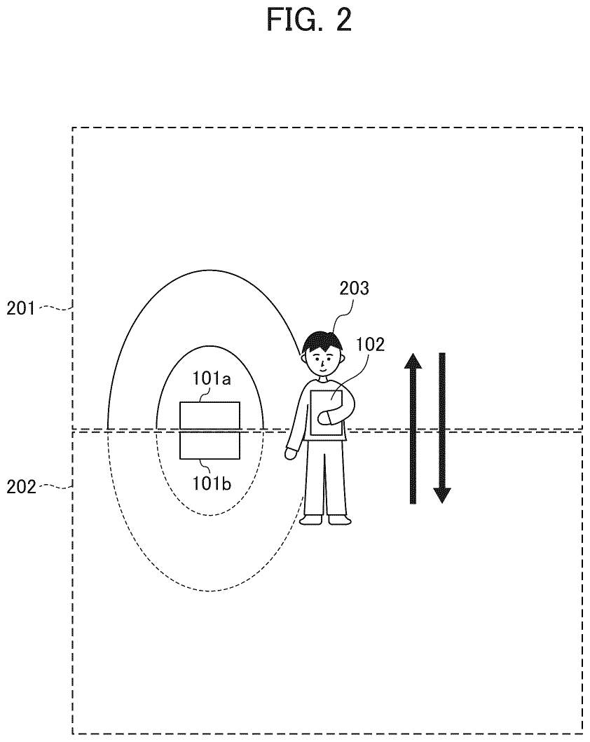

For instance, when the radio wave intensity of the first signal 111a is higher than or equal to the radio wave intensity of the second signal 111b, the server 103 geolocates the communication terminal 102 by analyzing the identification information of the first transmission terminal 101a and the radio wave intensity of the first signal 111a represented by the first signal data 112a. Alternatively, when the radio wave intensity of the first signal 111a is lower than the radio wave intensity of the second signal 111b, the server 103 geolocates the communication terminal 102 by analyzing the identification information of the second transmission terminal 101b and the radio wave intensity of the second signal 111b represented by the second signal data 112b. FIG. 2 is a diagram of exemplary locations of the first transmission terminal 101a and the second transmission terminal 101b.

The first transmission terminal 101a transmits the first signal 111a by emitting the first signal 111a in a first main emission direction that points to the interior of a first area 201. The first main emission direction is the direction in which the first signal 111a exhibits a maximum radio wave intensity. Therefore, the first signal 111a exhibits a higher radio wave intensity in the interior of the first area 201 than in the exterior of the first area 201.

The second transmission terminal 101b transmits the second signal 111b by emitting the second signal 111b in a second main emission direction that points to the interior of a second area 202. The second main emission direction is the direction in which the second signal 111b exhibits a maximum radio wave intensity. Therefore, the second signal 111b exhibits a higher radio wave intensity in the interior of the second area 202 than in the exterior of the second area 202.

The first transmission terminal 101a and the second transmission terminal 101b are disposed along a boundary between the first area 201 and the second area 202. Note that the first transmission terminal 101a and the second transmission terminal 101b may be separated by a distance. When the communication terminal 102 is located in the same direction with respect to the first transmission terminal 101a and the second transmission terminal 101b, the radio wave intensity of the first signal 111a and the radio wave intensity of the second signal 111b share the same environment factors.

For instance, the first transmission terminal 101a and the second transmission terminal 101b are disposed back to back. In such a case, the first main emission direction and the second main emission direction are opposite each other. Note that the first transmission terminal 101a and the second transmission terminal 101b need only to have directionality in their radio wave intensity, and the locations of the first transmission terminal 101a and the second transmission terminal 101b are not necessarily limited.

For instance, when the communication terminal 102 is in the first area 201, the radio wave intensity of the first signal 111a is higher than the radio wave intensity of the second signal 111b. Then, when the communication terminal 102 moves from the first area 201 to the second area 202, there occurs a change from a state of the radio wave intensity of the first signal 111a being higher than the radio wave intensity of the second signal 111b to a state of the radio wave intensity of the first signal 111a being lower than the radio wave intensity of the second signal 111b. In addition, when the communication terminal 102 moves from the second area 202 to the first area 201, there occurs a change from a state of the radio wave intensity of the first signal 111a being lower than the radio wave intensity of the second signal 111b to a state of the radio wave intensity of the first signal 111a being higher than the radio wave intensity of the second signal 111b.

In addition, when the first transmission terminal 101a and the second transmission terminal 101b are disposed along the boundary between the first area 201 and the second area 202, and there is a person 203 carrying the communication terminal 102 both between the first transmission terminal 101a and the communication terminal 102 and between the second transmission terminal 101b and the communication terminal 102, the radio waves transmitted by the first transmission terminal 101a and the second transmission terminal 101b are both absorbed by the person 203. Hence, the radio wave transmitted by either the first transmission terminal 101a or the second transmission terminal 101b alone is not absorbed by the person 203. Therefore, when the person 203 moves along the boundary between the first area 201 and the second area 202, the communication terminal 102 is unlikely to receive only the signal transmitted by either the first transmission terminal 101a or the second transmission terminal 101b.

Therefore, if a signal that exhibits a relatively high radio wave intensity is prioritized, the prioritized signal alternates between the first signal 111a and the second signal 111b when the person 203 moves across the boundary between the first area 201 and the second area 202. Therefore, the communication terminal 102 can detect the movement between the first area 201 and the second area by comparing the radio wave intensity of the first signal 111a and the radio wave intensity of the second signal 111b.

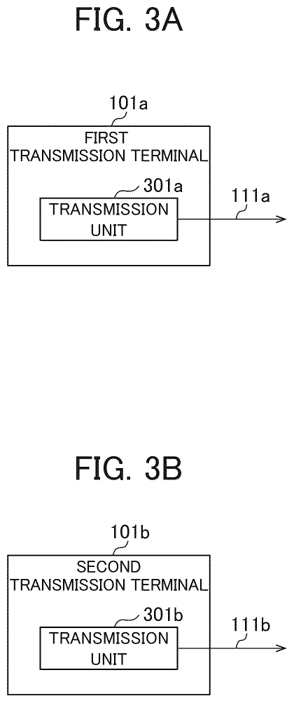

FIG. 3A is a block diagram of an exemplary configuration of the first transmission terminal 101a. The first transmission terminal 101a includes, for example, a transmission unit 301a. The transmission unit 301a transmits the first signal 111a on a plurality of frequencies by near-field communication.

FIG. 3B is a block diagram of an exemplary configuration of the second transmission terminal 101b. The second transmission terminal 101b includes, for example, a transmission unit 301b. The transmission unit 301b transmits the second signal 111b on a plurality of frequencies by near-field communication.

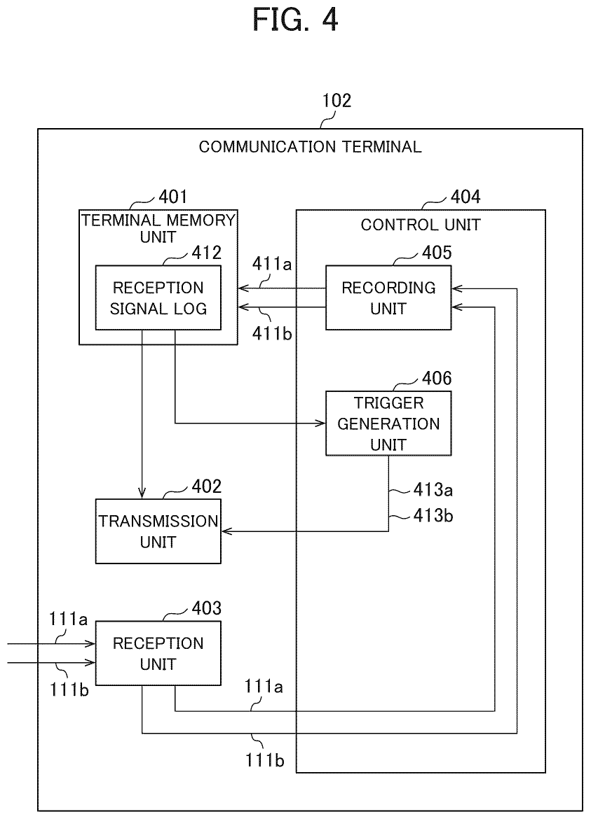

FIG. 4 is a block diagram of an exemplary configuration of the communication terminal 102. The communication terminal 102 includes, for example, a terminal memory unit 401, a reception unit 403, a control unit 404, and a transmission unit 402.

The terminal memory unit 401 is a storage medium capable of recording, for example, various data and programs and is built around, for example, a hard disk, an SSD (solid state drive), or a semiconductor memory. The terminal memory unit 401 contains, for example, a reception signal log 412 and a switching cycle 414. The reception signal log 412 records temporal changes of a first radio wave intensity 411a representing the radio wave intensity of the first signal 111a and temporal changes of a second radio wave intensity 411b representing the radio wave intensity of the second signal 111b.

The reception unit 403 receives the first signal 111a and the second signal 111b. Specifically, the reception unit 403 switches the selected channel for each switching cycle 414 and receives the first signal 111a and the second signal 111b through that selected channel.

The control unit 404 performs various processes in accordance with the programs and data stored in the terminal memory unit 401. The control unit 404 is provided by, for example, a processor such as a CPU (central processing unit).

The control unit 404 includes, for example, a recording unit 405 and a trigger generation unit 406.

The recording unit 405 records the first radio wave intensity 411a and the second radio wave intensity 411b. Specifically, the recording unit 405 records the first radio wave intensity 411a and the second radio wave intensity 411b in the reception signal log 412.

In response to a change from a state of the first radio wave intensity 411a being higher than the second radio wave intensity 411b to a state of the first radio wave intensity 411a being lower than the second radio wave intensity 411b, the trigger generation unit 406 generates a first trigger 413a. In addition, in response to a change from a state of the first radio wave intensity 411a being lower than the second radio wave intensity 411b to a state of the first radio wave intensity 411a being higher than the second radio wave intensity 411b, the trigger generation unit 406 generates a second trigger 413b.

The transmission unit 402 transmits the first trigger 413a to the server 103 in response to generation of the first trigger 413a. In addition, the transmission unit 402 transmits the second trigger 413b to the server 103 in response to generation of the second trigger 413b. Alternatively, the transmission unit 402 may transmit, to the server 103, not only the first trigger 413a and the second trigger 413b, but also the data representing the temporal changes of the first radio wave intensity 411a recorded in the reception signal log 412 and the temporal changes of the second radio wave intensity 411b recorded in the reception signal log 412.

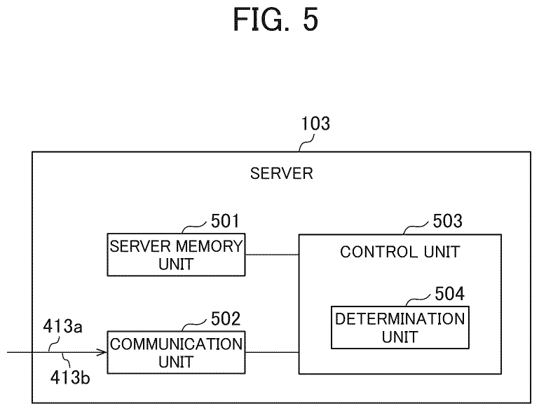

FIG. 5 is a block diagram of an exemplary configuration of the server 103. The server 103 includes, for example, a server memory unit 501, a communication unit 502, and a control unit 503.

The server memory unit 501 is a storage medium capable of recording, for example, various data and programs and is built around, for example, a hard disk, an SSD, or a semiconductor memory.

The server memory unit 501 contains the identification information of the first transmission terminal 101a and the location of the first transmission terminal 101a in an associated manner. Furthermore, the server memory unit 501 contains the identification information of the second transmission terminal 101b and the location of the second transmission terminal 101b in an associated manner. The communication unit 502 is an interface for connecting to, and hence communicating with, the network 104. The communication unit 502 receives the first trigger 413a and the second trigger 413b from the communication terminal 102 over the network 104.

The control unit 503 performs various processes in accordance with the programs and data stored in the server memory unit 501. The control unit 503 is provided by, for example, a processor such as a CPU. The control unit 503 includes, for example, a determination unit 504.

When the communication unit 502 has received the first trigger 413a, the determination unit 504 determines that the communication terminal 102 has moved from the first area 201 to the second area 202. When this is the case, the determination unit 504 determines that the communication terminal 102 belongs to the second area 202, until a new second trigger 413b is received. In addition, when the communication unit 502 has received the second trigger 413b, the determination unit 504 determines that the communication terminal 102 has moved from the second area 202 to the first area 201. When this is the case, the determination unit 504 determines that the communication terminal 102 belongs to the first area 201, until a new first trigger 413a is received.

Furthermore, the determination unit 504, upon determining that the communication terminal 102 belongs to the first area 201, geolocates the communication terminal 102 in the first area 201 on the basis of the identification information of the first transmission terminal 101a represented by the first signal data 112a and also on the basis of the first radio wave intensity 411a. In addition, the determination unit 504, upon determining that the communication terminal 102 belongs to the second area 202, geolocates the communication terminal 102 in the second area 202 on the basis of the identification information of the second transmission terminal 101b represented by the second signal data 112b and also on the basis of the second radio wave intensity 411b.

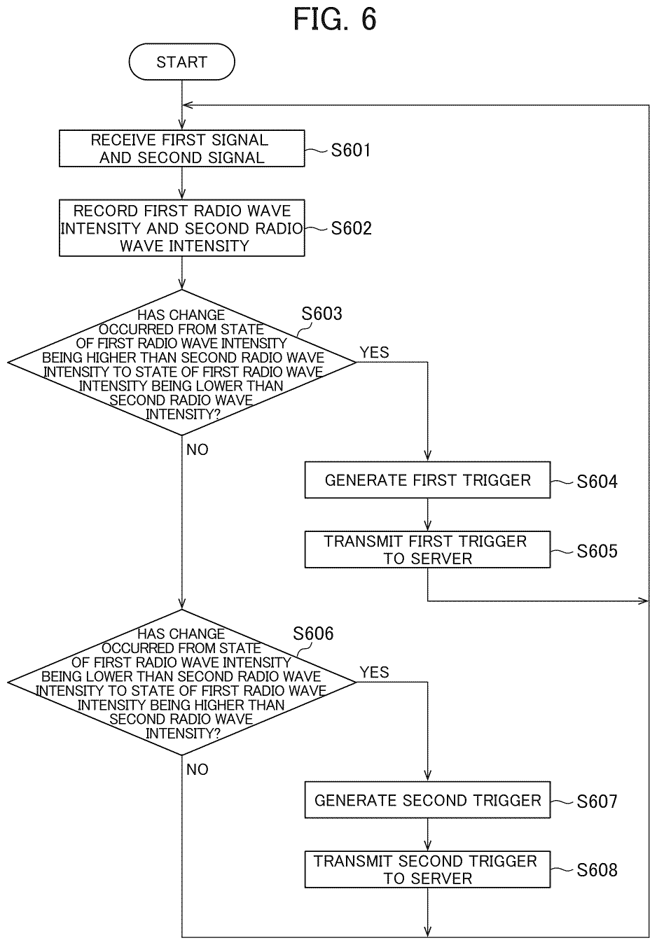

FIG. 6 is a flow chart representing an exemplary operation of the communication terminal 102 in accordance with the present embodiment.

In step S601, the reception unit 403 receives the first signal 111a and the second signal 111b. In step S602, the recording unit 405 records, in the reception signal log 412, the first radio wave intensity 411a representing the radio wave intensity of the received, first signal 111a and the second radio wave intensity 411b representing the radio wave intensity of the received, second signal 111b.

In step S603, the trigger generation unit 406 determines whether or not there has been a change from a state of the first radio wave intensity 411a being higher than the second radio wave intensity 411b to a state of the first radio wave intensity 411a being lower than the second radio wave intensity 411b.

If there has been, in step S603, a change from a state of the first radio wave intensity 411a being higher than the second radio wave intensity 411b to a state of the first radio wave intensity 411a being lower than the second radio wave intensity 411b, the trigger generation unit 406 generates the first trigger 413a in step S604. Then, in step S605, the transmission unit 402 transmits the first trigger 413a to the server 103. Then, the control unit 404 returns the process to step S601.

On the other hand, if there has been, in step S603, no change from a state of the first radio wave intensity 411a being higher than the second radio wave intensity 411b to a state of the first radio wave intensity 411a being lower than the second radio wave intensity 411b, the control unit 404 proceeds to perform step S606.

In step S606, the trigger generation unit 406 determines whether or not there has been a change from a state of the first radio wave intensity 411a being lower than the second radio wave intensity 411b to a state of the first radio wave intensity 411a being higher than the second radio wave intensity 411b.

If there has been, in step S606, no change from a state of the first radio wave intensity 411a being lower than the second radio wave intensity 411b to a state of the first radio wave intensity 411a being higher than the second radio wave intensity 411b, the control unit 404 returns the process to step S601. On the other hand, if there has been, in step S606, a change from a state of the first radio wave intensity 411a being lower than the second radio wave intensity 411b to a state of the first radio wave intensity 411a being higher than the second radio wave intensity 411b, the trigger generation unit 406 generates the second trigger 413b in step S607. Then, the transmission unit 402 transmits the second trigger 413b to the server 103. Then, the control unit 404 returns the process to step S601.

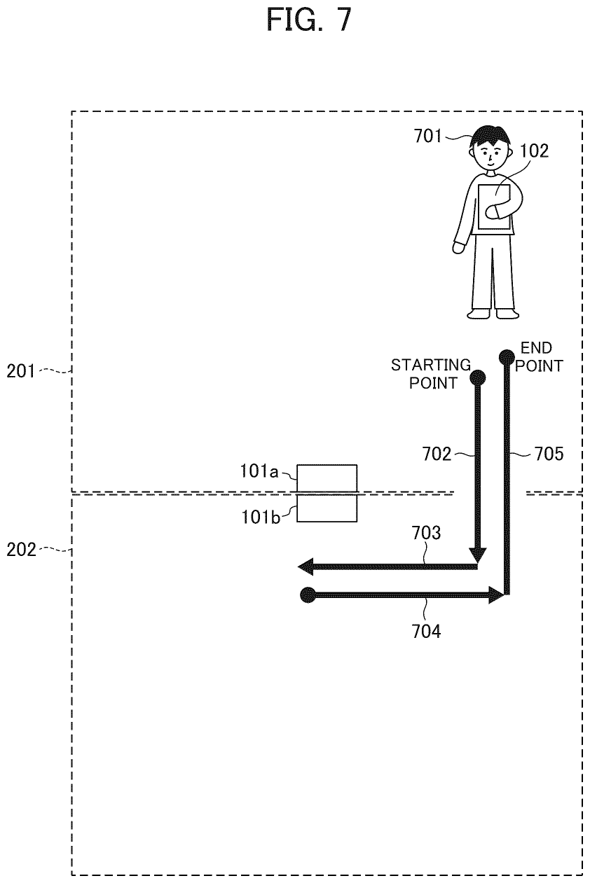

FIG. 7 is a diagram of exemplary travel paths of a person 701, carrying the communication terminal 102, moving between the first area 201 and the second area 202. The person 701, after moving from the first area 201 to the second area 202 along a travel path 702, moves in the second area along a travel path 703 and then along a travel path 704 and moves from the second area 202 to the first area 201 along a travel path 705.

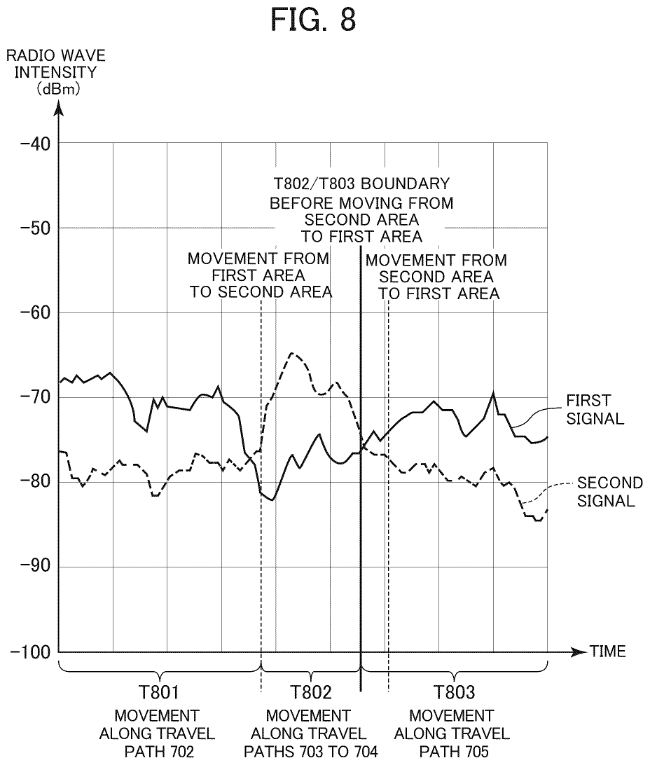

FIG. 8 is a graph representing examples of the first radio wave intensity 411a recorded in the reception signal log 412 and the second radio wave intensity 411b recorded in the reception signal log 412 when the person 701, carrying the communication terminal 102, has moved along the travel paths 702 to 705. FIG. 8 shows time on the horizontal axis and radio wave intensity on the vertical axis.

First, assume that during time T801, the person 701, carrying the communication terminal 102, moves from the first area 201 to the second area 202 along the travel path 702 indicated as an example in FIG. 7. As depicted as an example in FIG. 8, the first radio wave intensity 411a is higher than the second radio wave intensity 411b before the person 701, carrying the communication terminal 102, moves to the second area 202.

Then, when the communication terminal 102 moves from the first area 201 to the second area 202, there occurs a change from a state of the first radio wave intensity 411a being higher than the second radio wave intensity 411b to a state of the first radio wave intensity 411a being lower than the second radio wave intensity 411b. In other words, if a signal that exhibits a relatively high radio wave intensity is prioritized, the prioritized signal alternates between the first signal 111a and the second signal 111b when the communication terminal 102 moves from the first area 201 to the second area 202.

Then, assume that during time T802, the person 701, carrying the communication terminal 102, moves in the second area 202 along the travel path 703 and then along the travel path 704 indicated as an example in FIG. 7. When this is the case, as depicted as an example in FIG. 8, the first radio wave intensity 411a is lower than the second radio wave intensity 411b.

Then, assume that during time T803, the person 701, carrying the communication terminal 102, moves from the second area 202 to the first area 201 along the travel path 705 indicated as an example in FIG. 7. When the communication terminal 102 moves from the second area 202 to the first area 201, there occurs a change from a state of the first radio wave intensity 411a being lower than the second radio wave intensity 411b to a state of the first radio wave intensity 411a being higher than the second radio wave intensity 411b. In other words, the radio wave intensity alternates between the first radio wave intensity 411a and the second radio wave intensity 411b when the communication terminal 102 moves from the second area 202 to the first area 201. Therefore, as depicted as an example in FIG. 8, after the person 701, carrying the communication terminal 102, moves to the first area 201, the first radio wave intensity 411a is higher than the second radio wave intensity 411b.

As detailed so far, the first radio wave intensity 411a and the second radio wave intensity 411b change in accordance with the distance between the first transmission terminal 101a and the communication terminal 102 and the distance between the second transmission terminal 101b and the communication terminal 102. Therefore, the communication terminal 102 can generate a trigger representing the movement of the communication terminal 102 between the first area 201 and the second area 202, by comparing the first radio wave intensity 411a and the second radio wave intensity 411b. In other words, the communication terminal 102 can detect the communication terminal 102 moving between the first area 201 and the second area 202 near the area boundary. Furthermore, the communication terminal 102 transmits, to the server 103, a trigger representing the movement of the communication terminal 102 between the first area 201 and the second area 202. Hence, the server 103 can determine, on the basis of the received trigger, whether or not the communication terminal 102 has moved between the areas.

### Variation Example

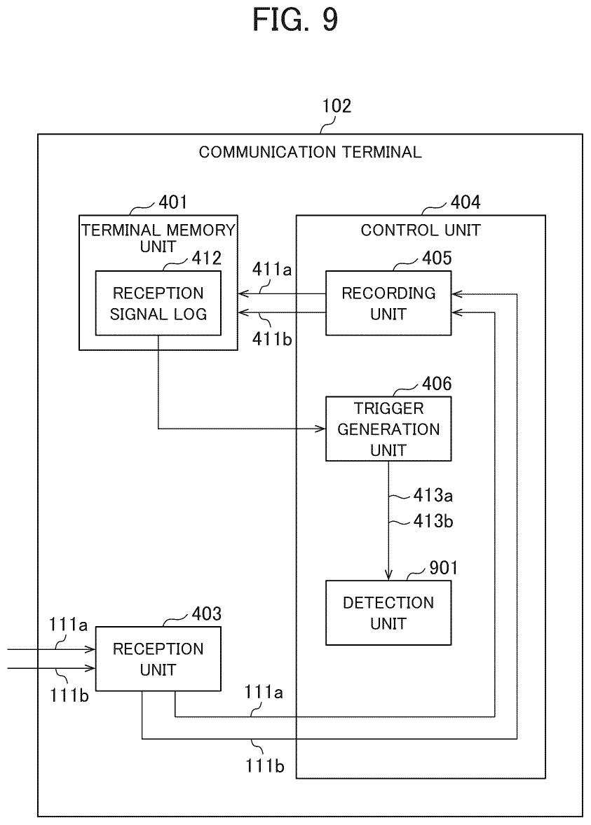

As a variation example of the communication system 100 in accordance with Embodiment 1, the communication terminal 102 may detect and determine whether or not the communication terminal 102 has moved between the areas. FIG. 9 is a block diagram of an exemplary configuration of the communication terminal 102 in accordance with the present variation example. The communication terminal 102 shown as an example in FIG. 9 differs from the communication terminal 102 shown as an example in FIG. 4 in that the communication terminal 102 shown as an example in FIG. 9 includes a detection unit 901 in place of the transmission unit 402.

The detection unit 901 detects a movement from the first area 201 to the second area 202 in response to generation of the first trigger 413a, and in addition, the detection unit 901 detects a movement from the second area 202 to the first area 201 in response to generation of the second trigger 413b. Therefore, the communication terminal 102 in accordance with the present variation example is capable of detecting a movement between the areas without having to transmitting the first trigger 413a and the second trigger 413b to the server 103.

### Embodiment 2

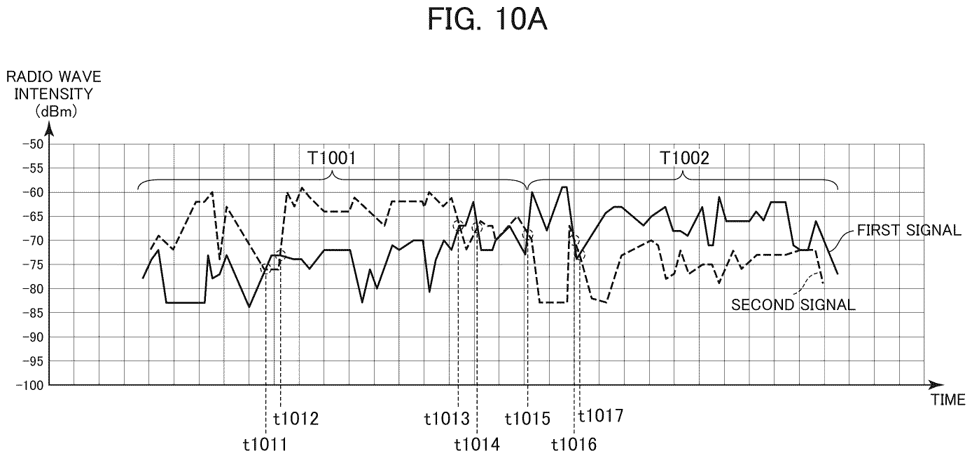

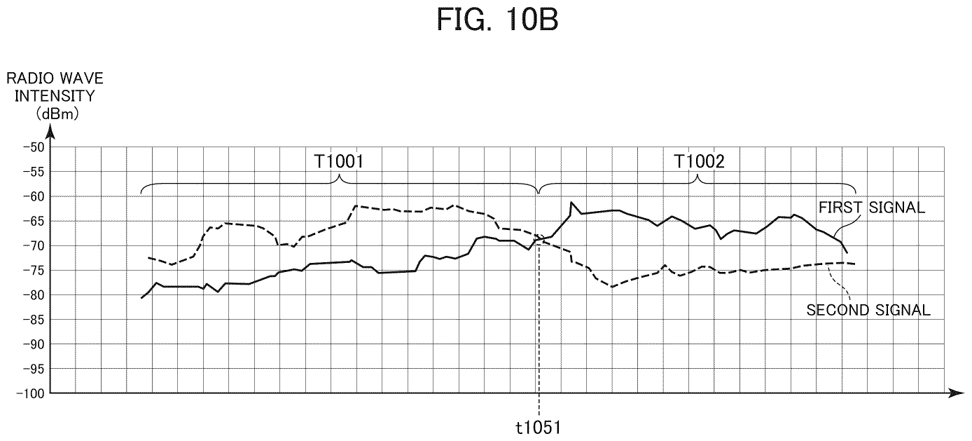

A description is now given of Embodiment 2 with reference to FIGS. 10A to 10B. Note that identical and similar elements in the drawings are denoted by the same reference numerals, and redundant description may be omitted. The members and processes of the present embodiment that have practically the same arrangement and function as the members and processes of the other embodiments are denoted by the same reference numerals, and the description focuses on differences from the other embodiments.

The communication terminal 102 in accordance with the present embodiment has a configuration that is similar to the configuration of the communication terminal 102 shown as an example in FIG. 4.

The trigger generation unit 406 in accordance with the present embodiment calculates an average travel value of the radio wave intensity of the first signal 111a as the first radio wave intensity 411a. The average travel value of the radio wave intensity of the first signal 111a is an average travel value over a period that is longer than or equal to the switching cycle 414. Furthermore, the trigger generation unit 406 calculates an average travel value of the radio wave intensity of the second signal 111b as the second radio wave intensity 411b. The average travel value of the radio wave intensity of the second signal 111b is an average travel value over a period that is longer than or equal to the switching cycle 414. In other words, the first radio wave intensity 411a in accordance with the present embodiment represents the average travel value of the radio wave intensity of the first signal 111a. In addition, the second radio wave intensity 411b in accordance with the present embodiment represents the average travel value of the radio wave intensity of the second signal 111b.

FIG. 10A is a graph representing exemplary radio wave intensities of the first signal 111a and the second signal 111b. FIG. 10A shows time on the horizontal axis and radio wave intensity on the vertical axis. Assume that the communication terminal 102 belongs to the first area 201 in period T1001. Assume also that the communication terminal 102 belongs to the second area 202 in period T1002. Here, at point in time t1015 which corresponds to the boundary between period T1001 and period T1002, there is a change from a state of the radio wave intensity of the first signal 111a being higher than the radio wave intensity of the second signal 111b to a state of the radio wave intensity of the first signal 111a being lower than the radio wave intensity of the second signal 111b. Therefore, it is inferred that the communication terminal 102 moves from the first area 201 to the second area 202 at point in time t1015.

However, there is a change from a state of the radio wave intensity of the first signal 111a being higher than the radio wave intensity of the second signal 111b to a state of the radio wave intensity of the first signal 111a being lower than the radio wave intensity of the second signal 111b also at point in time t1011, point in time t1013, and point in time t1017. In addition, there is a change from a state of the radio wave intensity of the first signal 111a being higher than the radio wave intensity of the second signal 111b to a state of the radio wave intensity of the first signal 111a being lower than the radio wave intensity of the second signal 111b at point in time t1012, point in time t1014, and point in time t1016.

As described here, even when the communication terminal 102 does not move between the first area 201 and the second area 202, there are cases where the signal that has a relatively high radio wave intensity temporarily alternates if the variations of the radio wave intensity of the first signal 111a and the variations of the radio wave intensity of the second signal 111b are relatively large.

FIG. 10B is a graph representing exemplary average travel values of the radio wave intensity of the first signal 111a shown as an example in FIG. 10A and the radio wave intensity of the second signal 111b shown as an example in FIG. 10A. FIG. 10B shows time on the horizontal axis and radio wave intensity on the vertical axis.

At point in time t1051, there is a change from a state of the average travel value of the radio wave intensity of the first signal 111a being higher than the average travel value of the radio wave intensity of the second signal 111b to a state of the average travel value of the radio wave intensity of the first signal 111a being lower than the average travel value of the radio wave intensity of the second signal 111b. On the other hand, during period T1001 and period T1002, there is no change from a state of the average travel value of the radio wave intensity of the first signal 111a being higher than the average travel value of the radio wave intensity of the second signal 111b to a state of the average travel value of the radio wave intensity of the first signal 111a being lower than the average travel value of the radio wave intensity of the second signal 111b. Therefore, the communication terminal 102 in accordance with the present embodiment is capable of preventing the trigger generation unit 406 from generating the first trigger 413a or the first trigger 413a when there is no movement between the first area 201 and the second area 202, by the first radio wave intensity 411a representing the average travel value of the radio wave intensity of the first signal 111a and the second radio wave intensity 411b representing the average travel value of the radio wave intensity of the second signal 111b.

### Variation Example

As a variation example of the communication system 100 in accordance with Embodiment 1, if a signal that exhibits a relatively high radio wave intensity is prioritized, the communication terminal 102 may generate the first trigger 413a or the second trigger 413b when the prioritized signal alternates between the first radio wave intensity 411a and the second radio wave intensity 411b in a period that accounts for a majority of the switching cycle 414. Specifically, the trigger generation unit 406 may generate the first trigger 413a in response to a change from a state of the length of time in which the first radio wave intensity 411a is higher than the second radio wave intensity 411b accounting for a majority of the switching cycle 414 to a state of the length of time in which the first radio wave intensity 411a is lower than the second radio wave intensity 411b accounting for a majority of the switching cycle 414. In addition, the trigger generation unit 406 may generate the second trigger 413b in response to a change from a state of the length of time in which the first radio wave intensity 411a is lower than the second radio wave intensity 411b accounting for a majority of the switching cycle 414 to a state of the length of time in which the first radio wave intensity 411a is higher than the second radio wave intensity 411b accounting for a majority of the switching cycle 414.

In other words, the communication terminal 102 in accordance with the present variation example generates the first trigger 413a when the first radio wave intensity 411a is higher than the second radio wave intensity 411b in a stable manner over a period that accounts for a majority of the switching cycle 414. Similarly, the communication terminal 102 in accordance with the present variation example generates the second trigger 413b when the first radio wave intensity 411a is lower than the second radio wave intensity 411b in a stable manner over a period that accounts for a majority of the switching cycle 414. Therefore, the communication terminal 102 in accordance with the present variation example does not calculate an average travel value, thereby preventing erroneously generating the first trigger 413a or the first trigger 413a, when the communication terminal 102 does not move between the first area 201 and the second area 202.

### Embodiment 3

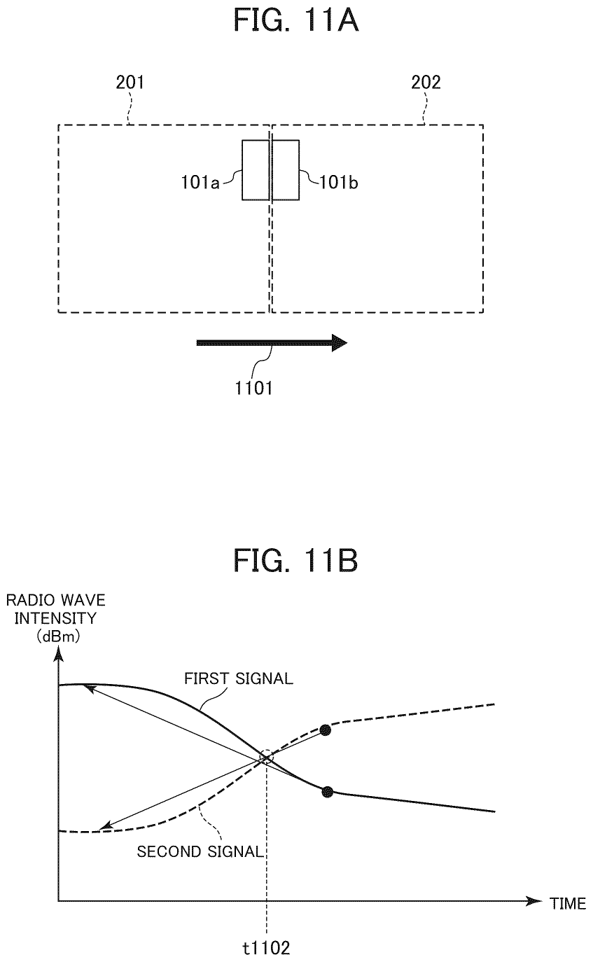

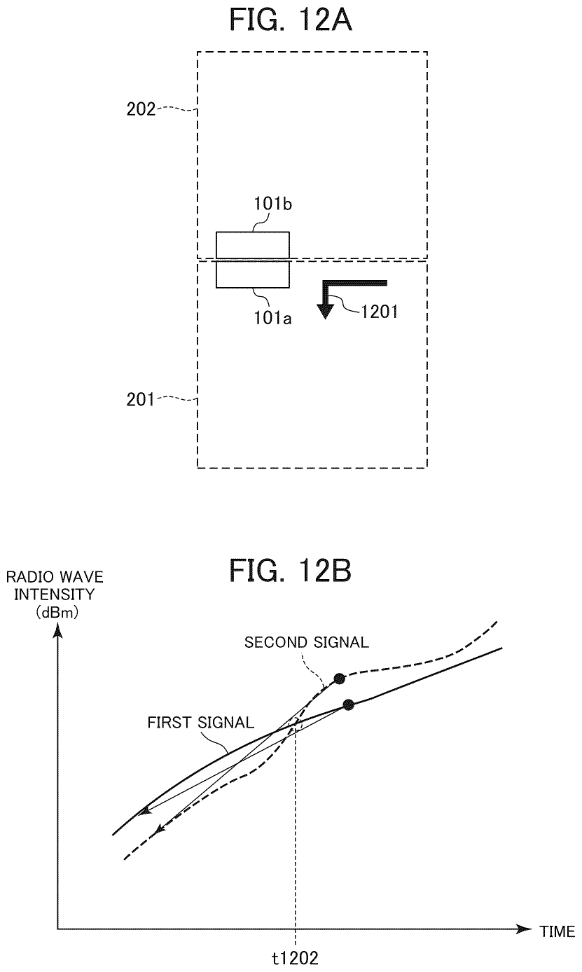

A description is now given of Embodiment 3 with reference to FIGS. 11A to 12B. Note that identical and similar elements in the drawings are denoted by the same reference numerals, and redundant description may be omitted. The members and processes of the present embodiment that have practically the same arrangement and function as the members and processes of the other embodiments are denoted by the same reference numerals, and the description focuses on differences from the other embodiments.

The communication terminal 102 in accordance with the present embodiment has the configuration shown in FIG. 4.

If the first radio wave intensity 411a is decreasing, and the second radio wave intensity 411b is increasing, at a point in time when there occurs a change from a state of the first radio wave intensity 411a being higher than the second radio wave intensity 411b to a state of the first radio wave intensity 411a being lower than the second radio wave intensity 411b, the trigger generation unit 406 in accordance with the present embodiment generates the first trigger 413a. In addition, if the first radio wave intensity 411a is increasing, and the second radio wave intensity 411b is decreasing, at a point in time when there occurs a change from a state of the first radio wave intensity 411a being lower than the second radio wave intensity 411b to a state of the first radio wave intensity 411a being higher than the second radio wave intensity 411b, the trigger generation unit 406 generates the second trigger 413b.

FIG. 11A is a diagram of an exemplary travel path 1101 of the communication terminal 102 moving between the first area 201 and the second area 202. FIG. 11B is a graph representing exemplary temporal changes of the first radio wave intensity 411a and the second radio wave intensity 411b when the communication terminal 102 moves along the travel path 1101 indicated as an example in FIG. 11A. FIG. 11B shows time on the horizontal axis and radio wave intensity on the vertical axis.

Assume that the communication terminal 102 belongs to the first area 201 at points in time before point in time t1102. Meanwhile, assume that the communication terminal 102 belongs to the second area 202 at points in time after point in time t1102. In addition, there is a change from a state of the first radio wave intensity 411a being higher than the second radio wave intensity 411b to a state of the first radio wave intensity 411a being lower than the second radio wave intensity 411b at point in time t1102. Furthermore, the first radio wave intensity 411a continuously decreases, and the second radio wave intensity 411b continuously increases, from a point in time before point in time t1102 to a point in time after point in time t1102. In other words, when the communication terminal 102 moves between the first area 201 and the second area 202, the slope of the first radio wave intensity 411a and the slope of the second radio wave intensity 411b have opposite signs in the temporal changes of the first radio wave intensity 411a and the temporal changes of the second radio wave intensity 411b.

FIG. 12A is a diagram of an exemplary travel path 1201 of the communication terminal 102 moving in the first area 201. FIG. 12B is a graph representing exemplary temporal changes of the first radio wave intensity 411a and exemplary temporal changes of the second radio wave intensity 411b when the communication terminal 102 moves along the travel path 1201 indicated as an example in FIG. 12A. FIG. 12B shows time on the horizontal axis and radio wave intensity on the vertical axis.

At point in time t1202, there is a change from a state of the first radio wave intensity 411a being higher than the second radio wave intensity 411b to a state of the first radio wave intensity 411a being lower than the second radio wave intensity 411b. However, the first radio wave intensity 411a and the second radio wave intensity both continuously increase from a point in time before point in time t1202 to a point in time after point in time t1202.

Therefore, the trigger generation unit 406 in accordance with the present embodiment can determine whether or not to generate the first trigger 413a or the second trigger 413b, without having to calculate the average travel value of the first radio wave intensity 411a and the average travel value of the second radio wave intensity 411b.

Furthermore, to calculate the average travel value of the first radio wave intensity 411a and the average travel value of the second radio wave intensity 411b, the trigger generation unit 406 cannot determine whether or not to generate the first trigger 413a or the second trigger 413b until a period that is longer than or equal to the switching cycle 414 elapses.

In contrast, the trigger generation unit 406 in accordance with the present embodiment can determine whether or not to generate the first trigger 413a or the second trigger 413b before a period that is longer than or equal to the switching cycle 414 elapses, without having to calculate the average travel value of the first radio wave intensity 411a and the average travel value of the second radio wave intensity 411b.

Therefore, when the communication terminal 102 is not moving between the first area 201 and the second area 202, the communication terminal 102 in accordance with the present embodiment can determine whether or not to generate the first trigger 413a or the second trigger 413b in a relatively short time while preventing erroneously generating the first trigger 413a or the second trigger 413b.

### Embodiment 4

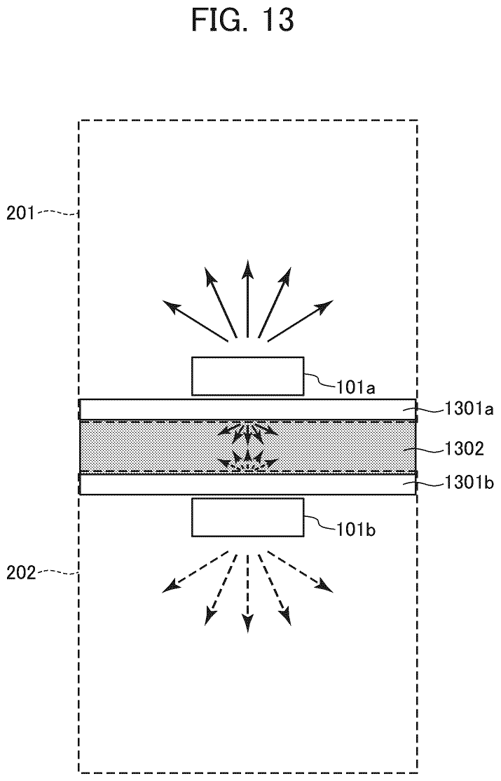

A description is now given of Embodiment 4 with reference to FIG. 13. Note that identical and similar elements in the drawings are denoted by the same reference numerals, and redundant description may be omitted. The members and processes of the present embodiment that have practically the same arrangement and function as the members and processes of the other embodiments are denoted by the same reference numerals, and the description focuses on differences from the other embodiments.

The communication terminal 102 in accordance with the present embodiment has the configuration shown in FIG. 4.

FIG. 13 is a diagram of exemplary locations of the first transmission terminal 101a and the second transmission terminal 101b in the communication system 100 in accordance with the present embodiment. The communication system 100 in accordance with the present embodiment further includes a first radio wave reflector 1301a and a second radio wave reflector 1301b. In addition, the radio wave reflector may be replaced by a radio wave absorber. Examples of the material for the radio wave absorber include urethane, rubber, and water.

The first radio wave reflector 1301a is disposed on the second area 202 side to impart a first main emission direction to the first transmission terminal 101a. For example, the first radio wave reflector 1301a is disposed on a surface of a wall member 1302 disposed on the boundary between the first area 201 and the second area 202, the surface facing the first area 201.

The first radio wave reflector 1301a is composed of a metal and has a larger area than the first transmission terminal 101a. For example, the first radio wave reflector 1301a has an area at least 10 times the area of the second-area-202-side surface of the first transmission terminal 101a.

By the first radio wave reflector 1301a being disposed on the second area 202 side, the first signal 111a transmitted by the first transmission terminal 101a toward the second area 202 side is reflected by the first radio wave reflector 1301a. Hence, the radio wave intensity of the first signal 111a transmitted by the first transmission terminal 101a toward the second area 202 side becomes lower than the radio wave intensity of the first signal 111a transmitted by the first transmission terminal 101a toward the first area 201 side. As a result, the first transmission terminal 101a comes to exhibit the first main emission direction that points to the interior of the first area 201, thereby being capable of producing a directional radio wave intensity.

In addition, when the first radio wave reflector 1301a is replaced by a radio wave absorber, the first signal 111a transmitted by the first transmission terminal 101a toward the second area 202 side is absorbed by the radio wave absorber. Hence, the radio wave intensity of the first signal 111a transmitted by the first transmission terminal 101a toward the second area 202 side becomes lower than the radio wave intensity of the first signal 111a transmitted by the first transmission terminal 101a toward the first area 201 side. As a result, the first transmission terminal 101a comes to exhibit the first main emission direction that points to the interior of the first area 201, thereby being capable of producing a directional radio wave intensity.

The second radio wave reflector 1301b is disposed on the first area 201 side to impart a second main emission direction to the second transmission terminal 101b. For example, the second radio wave reflector 1301b is disposed on a surface of the wall member 1302 facing the second area 202.

The second radio wave reflector 1301b is composed of a metal and has a relatively larger area than the second transmission terminal 101b. For example, the second radio wave reflector 1301b has an area at least 10 times the area of the first-area-201-side surface of the second transmission terminal 101b.

By the second radio wave reflector 1301b being disposed on the first area 201 side, the second signal 111b transmitted by the second transmission terminal 101b toward the first area 201 side is reflected by the second radio wave reflector 1301b. Hence, the radio wave intensity of the second signal 111b transmitted by the second transmission terminal 101b toward the first area 201 side becomes lower than the radio wave intensity of the second signal 111b transmitted by the second transmission terminal 101b toward the second area 202 side. As a result, the second transmission terminal 101b comes to exhibit the first main emission direction that points to the interior of the second area 202, thereby being capable of producing a directional radio wave intensity.

In addition, when the second radio wave reflector 1301b is replaced by a radio wave absorber, the second signal 111b transmitted by the second transmission terminal 101b toward the first area 201 side is absorbed by the radio wave absorber. Hence, the radio wave intensity of the second signal 111b transmitted by the second transmission terminal 101b toward the first area 201 side becomes lower than the radio wave intensity of the second signal 111b transmitted by the second transmission terminal 101b toward the second area 202 side. As a result, the second transmission terminal 101b comes to exhibit the first main emission direction that points to the interior of the second area 202, thereby being capable of producing a directional radio wave intensity.

As detailed so far, the first transmission terminal 101a can produce a directional radio wave intensity owing to the inclusion of the first radio wave reflector 1301a. Similarly, the second transmission terminal 101b can produce a directional radio wave intensity owing to the inclusion of the second radio wave reflector 1301b. Hence, when a person carrying the communication terminal 102 moves from the first area 201 to the second area 202, there occurs a change from a state of the first radio wave intensity 411a being higher than the second radio wave intensity 411b to a state of the first radio wave intensity 411a being lower than the second radio wave intensity 411b. In addition, when a person carrying the communication terminal 102 moves from the second area 202 to the first area 201, there occurs a change from a state of the first radio wave intensity 411a being lower than the second radio wave intensity 411b to a state of the first radio wave intensity 411a being higher than the second radio wave intensity 411b.

### Embodiment 5

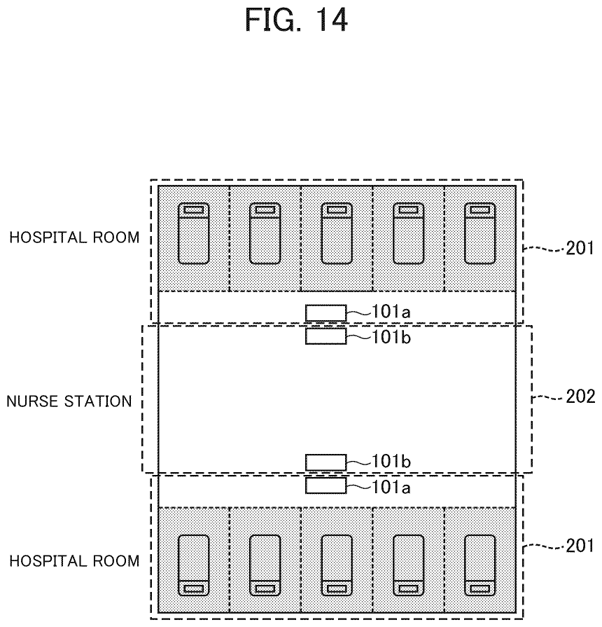

A description is now given of Embodiment 5 with reference to FIG. 14. Note that identical and similar elements in the drawings are denoted by the same reference numerals, and redundant description may be omitted. The members and processes of the present embodiment that have practically the same arrangement and function as the members and processes of the other embodiments are denoted by the same reference numerals, and the description focuses on differences from the other embodiments.

The communication terminal 102 in accordance with the present embodiment has the configuration shown in FIG. 9. In addition, the server 103 in accordance with the present embodiment has the configuration shown in FIG. 5.

The trigger generation unit 406 in accordance with the present embodiment calculates an average travel value of the radio wave intensity of the first signal 111a as the first radio wave intensity 411a. The average travel value of the radio wave intensity of the first signal 111a in accordance with the present embodiment is an average travel value over a period that is in accordance with the area to which the communication terminal 102 belongs.

In addition, the trigger generation unit 406 calculates an average travel value of the radio wave intensity of the second signal 111b as the second radio wave intensity 411b. The average travel value of the radio wave intensity of the second signal 111b in accordance with the present embodiment is an average travel value over a period that is in accordance with the area to which the communication terminal 102 belongs.

According to the detection unit 901 in accordance with the present embodiment, in response to generation of the first trigger 413a, the communication terminal 102 switches from a first transmission interval to a second transmission interval by detecting a movement from the first area 201 to the second area 202. In addition, in response to generation of the second trigger 413b, according to the detection unit 901, the communication terminal 102 switches from the second transmission interval to the first transmission interval by detecting a movement from the second area 202 to the first area 201.

When the communication terminal 102 belongs to the first area 201, the transmission unit 402 in accordance with the present embodiment transmits the first signal 111a to the server 103 at the first transmission interval. In addition, when the communication terminal 102 belongs to the second area 202, the transmission unit 402 transmits the second signal 111b to the server 103 at the second transmission interval.

For instance, when the communication terminal 102 belongs to an area where relatively low geolocation precision is allowed in geolocation based on the reception intensity of the first signal 111a and geolocation based on the reception intensity of the second signal 111b, the period for calculating an average travel value of radio wave intensity is made relatively long. For example, when the communication terminal 102 belongs to an area where relatively low geolocation precision is allowed, the trigger generation unit 406 calculates an average travel value of radio wave intensity over 1 minute.

On the other hand, for example, when the communication terminal 102 belongs to an area where relatively high geolocation precision is required, the period for calculating an average travel value of radio wave intensity is made relatively short. For example, when the communication terminal 102 belongs to an area where relatively high geolocation precision is required, the trigger generation unit 406 calculates an average travel value of radio wave intensity over 10 seconds.

In addition, the transmission unit 402 may transmit the first signal data 112a or the second signal data 112b to the server 103 at a transmission interval that is in accordance with the area to which the communication terminal 102 belongs. For example, the transmission unit 402 shortens the transmission interval at which the first signal data 112a or the second signal data 112b is transmitted to the server 103 when the communication terminal 102 belongs to an area where relatively high geolocation precision is required over when the communication terminal 102 belongs to an area where relatively low geolocation precision is allowed. Alternatively, when the communication terminal 102 belongs to an area where relatively low geolocation precision is allowed, the transmission unit 402 may not transmit the first signal data 112a and the second signal data 112b to the server 103.

FIG. 14 is a diagram of an exemplary environment in which the first transmission terminal 101a and the second transmission terminal 101b are installed in the first area 201 and the second area 202.

For instance, assume that in a medical facility, the first area 201 is a hospital room where beds are arranged, and the second area 202 is a nurse station. Then, assume that geolocation precision is required to be relatively higher in the hospital room than in the nurse station. Furthermore, assume that the first transmission terminal 101a is installed in the hospital room, and the second transmission terminal 101b is installed in the nurse station.

For instance, the period for calculating an average travel value of radio wave intensity is made relatively shorter when the communication terminal 102 belongs to the first area 201 than when the communication terminal 102 belongs to the second area 202. In addition, when the communication terminal 102 belongs to the first area 201, the transmission unit 402 may transmit the first signal data 112a to the server 103 at a relatively short transmission interval. When this is the case, the determination unit 504 is capable of geolocating the communication terminal 102 in the first area 201 at relatively high frequency on the basis of the identification information represented by the received, first signal data 112a and also on the basis of the first radio wave intensity 411a. In other words, when the communication terminal 102 belongs to an area where relatively high geolocation precision is required, relatively high geolocation precision can be ensured by performing geolocation at relatively high frequency.

Meanwhile, when the communication terminal 102 belongs to the second area 202, the transmission unit 402 transmits the second signal data 112b to the server 103 at a relatively long transmission interval. Alternatively, when the communication terminal 102 belongs to the second area 202, the transmission unit 402 does not transmit the first signal data 112a and the second signal data 112b to the server 103. Hence, when the communication terminal 102 belongs to an area where relatively low geolocation precision is allowed, power consumption is reduced.

As detailed so far, the communication system 100 in accordance with the present embodiment is capable of geolocating the communication terminal 102 with precision that is in accordance with an area to which the communication terminal 102 belongs, by the communication terminal 102 and the server 103 communicating with each other at a communication interval that is in accordance with the area to which the communication terminal 102 belongs.

The processes executed in the above embodiments are not limited to the processing modes described in the above embodiments. The functional blocks described above may be implemented using either logic circuits (hardware) formed on integrated circuits or the like or software run by a CPU. Each process executed in the above embodiments may be executed by a plurality of computers. For example, some of the processes executed by the functional blocks of the control unit 404 of the communication terminal 102 may be executed by another computer, or all of the processes may be shared and executed by a plurality of computers.

The present disclosure is not limited to the description of the embodiments and examples above. Any structure detailed in the embodiments and examples may be replaced by a practically identical structure, a structure that delivers practically the same effect and function, or a structure that achieves practically the same purpose. Embodiments based on a proper combination of technical means disclosed in different embodiments are encompassed in the technical scope of the present disclosure. Furthermore, new technical features can be created by combining different technical means disclosed in the embodiments.

1. A communication terminal comprising:
a reception unit configured to receive a first signal and a second signal;
a recording unit configured to record a first radio wave intensity representing a radio wave intensity of the first signal and a second radio wave intensity representing a radio wave intensity of the second signal; and
a trigger generation unit configured to generate a first trigger in response to a change from a state of the first radio wave intensity being higher than the second radio wave intensity to a state of the first radio wave intensity being lower than the second radio wave intensity and to generate a second trigger in response to a change from a state of the first radio wave intensity being lower than the second radio wave intensity to a state of the first radio wave intensity being higher than the second radio wave intensity.

2. The communication terminal according to claim 1, wherein
the first radio wave intensity represents an average travel value of the radio wave intensity of the first signal, and
the second radio wave intensity represents an average travel value of the radio wave intensity of the second signal.

3. The communication terminal according to claim 2, wherein
the reception unit switches a selected channel for each switching cycle and receives the first signal and the second signal through the selected channel,
the average travel value of the radio wave intensity of the first signal is an average travel value over a period that is longer than or equal to the switching cycle, and
the average travel value of the radio wave intensity of the second signal is an average travel value over a period that is longer than or equal to the switching cycle.

4. The communication terminal according to claim 2, wherein
the average travel value of the radio wave intensity of the first signal is an average travel value over a period that is in accordance with an area to which the communication terminal belongs, and
the average travel value of the radio wave intensity of the second signal is an average travel value over a period that is in accordance with the area.

5. The communication terminal according to claim 1, wherein
the reception unit switches a selected channel for each switching cycle and receives the first signal and the second signal through the selected channel, and
the trigger generation unit generates the first trigger in response to a change from a state of a length of time in which the first radio wave intensity is higher than the second radio wave intensity accounting for a majority of the switching cycle to a state of a length of time in which the first radio wave intensity is lower than the second radio wave intensity accounting for a majority of the switching cycle and generates the second trigger in response to a change from a state of a length of time in which the first radio wave intensity is lower than the second radio wave intensity accounting for a majority of the switching cycle to a state of a length of time in which the first radio wave intensity is higher than the second radio wave intensity accounting for a majority of the switching cycle.

6. The communication terminal according to claim 1, wherein the trigger generation unit generates the first trigger if the first radio wave intensity is decreasing, and the second radio wave intensity is increasing, at a point in time when there occurs a change from a state of the first radio wave intensity being higher than the second radio wave intensity to a state of the first radio wave intensity being lower than the second radio wave intensity and generates the second trigger if the first radio wave intensity is increasing, and the second radio wave intensity is decreasing, at a point in time when there occurs a change from a state of the first radio wave intensity being lower than the second radio wave intensity to a state of the first radio wave intensity being higher than the second radio wave intensity.

7. The communication terminal according to claim 1, further comprising a detection unit configured to detect a movement of the communication terminal from a first area to a second area in response to generation of the first trigger and to detect a movement of the communication terminal from the second area to the first area in response to generation of the second trigger.

8. A communication system comprising:
a first transmission terminal configured to transmit a first signal;
a second transmission terminal configured to transmit a second signal; and
a communication terminal including:
a reception unit configured to receive the first signal and the second signal;
a recording unit configured to record a first radio wave intensity representing a radio wave intensity of the first signal and a second radio wave intensity representing a radio wave intensity of the second signal; and
a trigger generation unit configured to generate a first trigger in response to a change from a state of the first radio wave intensity being higher than the second radio wave intensity to a state of the first radio wave intensity being lower than the second radio wave intensity and to generate a second trigger in response to a change from a state of the first radio wave intensity being lower than the second radio wave intensity to a state of the first radio wave intensity being higher than the second radio wave intensity.

9. The communication system according to claim 8 further comprising a server communicable with the communication terminal, wherein the communication terminal further includes a transmission unit configured to transmit the first trigger to the server in response to generation of the first trigger and to transmit the second trigger to the server in response to generation of the second trigger.

10. The communication system according to claim 9, wherein the server includes a determination unit configured to determine that the communication terminal has moved from a first area to a second area in response to reception of the first trigger and to determine that the communication terminal has moved from the second area to the first area in response to reception of the second trigger.

11. The communication system according to claim 10, wherein
the first transmission terminal exhibits a first main emission direction that points to an interior of the first area, and
the second transmission terminal exhibits a second main emission direction that points to an interior of the second area.

12. The communication system according to claim 11, wherein the first main emission direction and the second main emission direction are opposite each other.

13. The communication system according to claim 11, wherein the first transmission terminal and the second transmission terminal are disposed back to back.

14. The communication system according to claim 11, wherein the first transmission terminal and the second transmission terminal are disposed along a boundary between the first area and the second area.

15. The communication system according to claim 11, further comprising:
a first radio wave reflector configured to impart the first main emission direction to the first transmission terminal; and
a second radio wave reflector configured to impart the second main emission direction to the second transmission terminal.

16. The communication system according to claim 11, further comprising:
a first radio wave absorber configured to impart the first main emission direction to the first transmission terminal; and
a second radio wave absorber configured to impart the second main emission direction to the second transmission terminal.

17. The communication system according to claim 10, wherein
the communication terminal further includes a detection unit configured so that the communication terminal detects a movement from the first area to the second area and switches from a first transmission interval to a second transmission interval in response to generation of the first trigger and that the communication terminal detects a movement from the second area to the first area and switches from the second transmission interval to the first transmission interval in response to generation of the second trigger, and
the transmission unit transmits the first signal to the server at the first transmission interval when the communication terminal belongs to the first area and transmits the second signal to the server at the second transmission interval when the communication terminal belongs to the second area.

18. A control method comprising:
receiving a first signal and a second signal;
recording a first radio wave intensity representing a radio wave intensity of the first signal and a second radio wave intensity representing a radio wave intensity of the second signal; and
generating:
a first trigger in response to a change from a state of the first radio wave intensity being higher than the second radio wave intensity to a state of the first radio wave intensity being lower than the second radio wave intensity; and
a second trigger in response to a change from a state of the first radio wave intensity being lower than the second radio wave intensity to a state of the first radio wave intensity being higher than the second radio wave intensity.

19. A non-transitory computer-readable recording medium containing a program causing a computer to perform:
recording a first radio wave intensity representing a radio wave intensity of a first signal and a second radio wave intensity representing a radio wave intensity of a second signal; and
generating:
a first trigger in response to a change from a state of the first radio wave intensity being higher than the second radio wave intensity to a state of the first radio wave intensity being lower than the second radio wave intensity; and
a second trigger in response to a change from a state of the first radio wave intensity being lower than the second radio wave intensity to a state of the first radio wave intensity being higher than the second radio wave intensity.
